(19) United States
(12) Patent Application Publication
(10) Pub. No.: US 2016/0125561 A1
(43) Pub. Date: May 5, 2016

(54) SYSTEM AND APPARATUS FOR SCHOLARSHIP SEARCHING

(71) Applicant: Scholly, Inc., Philadelphia, PA (US)

(72) Inventors: Christopher Gray, Philadelphia, PA (US); Bryson Alef, Madison, WI (US); Nicholas Pirollo, Somerville, MA (US)

(21) Appl. No.: 14/933,799

(22) Filed: Nov. 5, 2015

Related U.S. Application Data
(60) Provisional application No. 62/075,578, filed on Nov. 5, 2014.

(51) Int. Cl. G06Q 50/20; G06F 17/30; H04L 29/08

(52) U.S. Cl. CPC G06Q 50/2053; H04L 67/02; G06F 17/30867; G06F 17/30528

(57) ABSTRACT

A method for providing scholarship information to a student is disclosed. The method includes accessing a scholarship server and downloading scholarship information and storing the scholarship information in a database and then automatically categorizing the scholarship information. The method also includes receiving a request for scholarship matching from a mobile device, wherein the request includes biographical information. The method further includes, determining at least one scholarship match based on the scholarship information stored in the database and the received biographical information and transmitting the determined at least one scholarship match to the mobile device in a format that may be displayed on an app stored on the mobile device.

### CROSS REFERENCE TO RELATED APPLICATIONS

This application claims the benefit of priority, under 35 USC 119(e) of U.S. Provisional Patent Application No. 62/075,578, filed Nov. 5, 2014, the entire disclosure of which is hereby incorporated herein by reference.

### BACKGROUND OF THE INVENTION

College costs are soaring each year, while unemployment rises and families are strapped for cash. As a result, students are forced to take out thousands in student loans to fund their college educations. This has made many parents and students turn to scholarships to fund these educations. Unfortunately, these scholarships are not easy to find.

Scholly was created to make finding and applying for these scholarships a lot easier.

### SUMMARY OF THE INVENTION

Scholly is a mobile app that gives students a fast and simple way to find scholarships for college. Scholly uses eight specific parameters—such as state, race, GPA or major—to filter listings into a comprehensive directory of scholarships for which the prospective applicant is eligible. This same concept may be accessible via a web platform.

The web technology is the next step in the Scholly search process and comes in two parts—a Web API and a Web Platform. The web API is a programming interface meant for use by developers to provide a way for organizations to quickly integrate the search process into their existing or new applications. The API allows for building of portable interfaces that can be put up behind existing login portals or as web interfaces for quick turnaround for organizations.

### BRIEF DESCRIPTION OF THE DRAWINGS

A more detailed understanding may be had from the following description, given by way of example in conjunction with the accompanying drawings wherein:

FIG. 1 shows an exemplary system for scholarship searching and scholarship applications;

FIG. 2 shows a flow diagram for a method for implementing an API interface allowing a user to quickly search and apply for scholarships; and

FIGS. 3-15 show exemplary graphical user interface screens of a software app for a user to access the scholarship searching and application portal.

### DETAILED DESCRIPTION OF THE INVENTION

Disclosed herein are processor-executable methods, computing systems, and related technologies for accessing scholarship information using an automated application programming interface (API). The system and method may be accessed via software installed on a computer, via a web interface or by a software application (app) installed on a mobile computing device.

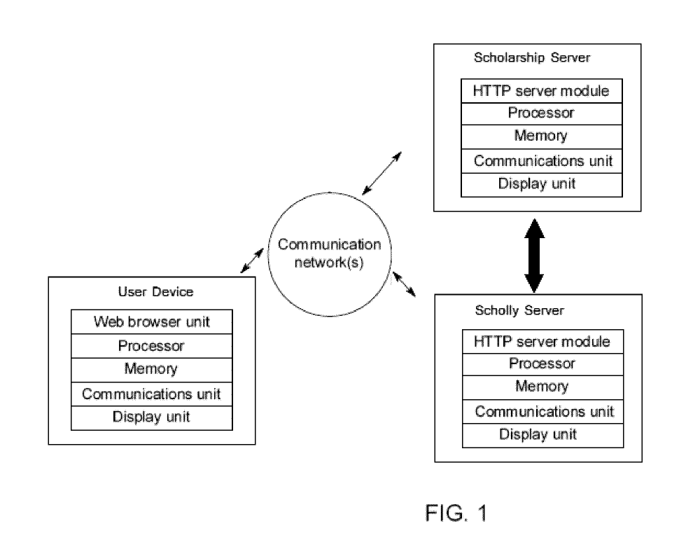

FIG. 1 shows an exemplary system that may be utilized for scholarship searching and applications. The exemplary system includes a user device, a scholarship server, and the Scholly information management server that may communicate over one or more wired and/or wireless communication networks. The wired or wireless communication networks may be public, private or a combination of public or private networks.

The user device may be, for example, a cellular phone, a smartphone, a desktop computer, a laptop computer, a tablet computer, or any other appropriate computing device. The user device includes a web browser unit, a processor, memory, a communications unit, and a display unit. The user device may communicate data to/from the HTTP server module(s) in the scholarship server and information management server. The web browser unit may include and/or communicate with one or more sub-modules that perform functionality such as rendering HTML (including but not limited to HTMLS), rendering raster and/or vector graphics, executing JAVASCRIPT, and/or rendering multimedia content.

Alternatively or additionally, the web browser unit may implement Rich Internet Application (RIA) and/or multimedia technologies such as ADOBE FLASH and/or other technologies compatible with Internet based communications. The web browser unit may implement RIA and/or multimedia technologies using one or web browser plug-in modules (e.g., ADOBE FLASH), and/or using one or more sub-modules within the web browser unit itself. The web browser unit may display data on one or more display devices (not depicted) that are included in or connected to the user device, such as a liquid crystal display (LCD) display or monitor. The user device may receive input from the user of the user device from input devices (not depicted) that are included in, or connected to, the user device, such as a keyboard, a mouse, a microphone or a touch screen, and provide data that indicates the input to the web browser unit.

The information management server may include an HTTP server module, a processor, memory, a communications unit, and a display unit. The information management server serves as a central resource to search for scholarships. A user using a user device may search for scholarships using an app or web browser unit installed on the user device.

The HTTP server module provides a website that may be accessed by a user device. The HTTP server module may implement the HTTP protocol, and may communicate Hypertext Markup Language (HTML) pages and related data from the website to/from the user device using HTTP. The information management server may be connected to one or more private or public networks (such as the Internet), via which the HTTP server module communicates with devices such as the user device. The HTTP server module may generate one or more web pages and may communicate the web pages to the user device, and may receive responsive information from the user device.

The HTTP server module may be, for example, an NGINX server APACHE HTTP server, a SUN-ONE Web Server, a MICROSOFT INTERNET Information Services (IIS) server, and/or may be based on any other appropriate HTTP server technology. The information management server may also include one or more additional components or modules (not depicted), such as one or more load balancers, firewall devices, routers, switches, and devices that handle power backup and data redundancy.

The processor may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform signal coding, data processing, power control, input/output processing, and/or any other functionality that enables the mobile device to operate in a wireless environment.

The memory may be configured to store information associated with user information and scholarship information. The memory may be any type of computer readable memory.

The communications unit may be configured with a transmitter and receiver and interface to allow the information management server to communicate with other devices.

The system may include one or more Scholarship servers. Each Scholarship server may include an HTTP server module, a processor, memory, a communications unit, and a display unit. The Scholarship server is managed by each individual institution or entity providing or managing a scholarship. For example, the Scholarship server may be managed by a foundation or University that is offering the scholarship. A user may access the Scholarship server through the information management server, or they may be redirected by Scholly directly to the scholarship server.

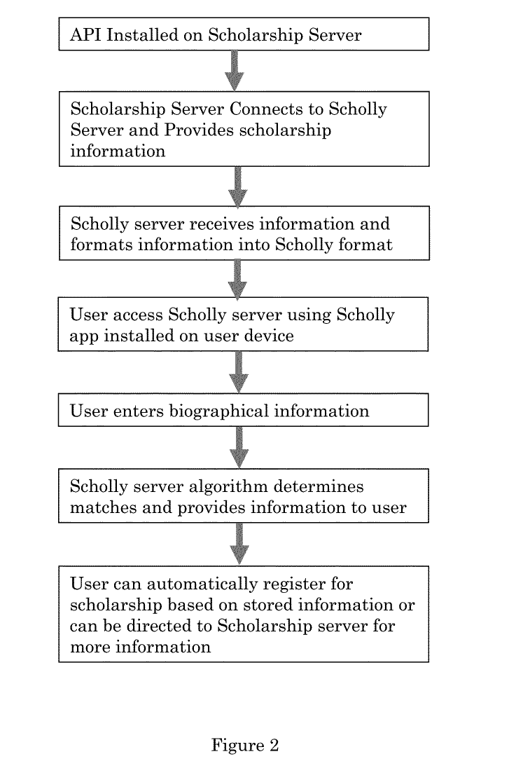

FIG. 2 shows a flow diagram for a method for implementing an API interface allowing a user to quickly search and apply for scholarships. To conveniently allow scholarships to be searchable by the public, a Scholarship server may install an API on their system. The API is configured to interface with the information management server. The information management server is able to receive information from the Scholarship server and format the information to make it accessible by Scholly users.

A student, using a user device with the Scholly app installed, may search the Scholly database. This may be done, for example by entering relevant biographical/educational information into the Scholly app. The Scholly app communicates this information to the information management server and using a computer-based algorithm, generates a list of scholarship matches. This information is sent to the user device, through the Scholly app, for review by the student. At this point, the student may read additional information/requirements about the scholarship, or they may apply directly, or they may be directed to a web page that instructs them how to apply.

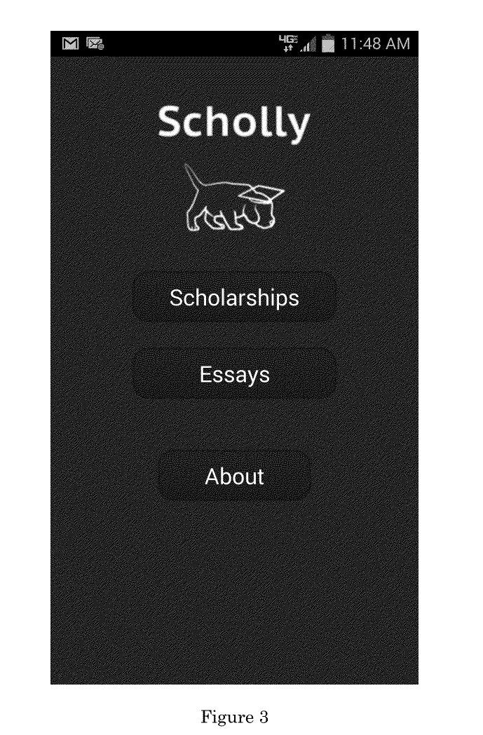

FIGS. 3-7 show exemplary interface pages of the Scholly app that may be displayed by the user device. As will be described in detail below, the interface pages may include display elements which allow the user of the user device to search for scholarship information, access stored essays, and apply for scholarships using the app.

FIG. 3 is an exemplary interface page of the Scholly app shown to a student as a home screen. As shown in FIG. 3, the page may include multiple input fields. The input fields allow a student to select a scholarship search, an essay search, or request information about Scholly. As the user device receives input for the input fields, the Scholly app may store one or more data structures that reflect the selections made in the input fields. Further, as the selections are updated, the Scholly app may update the interface page to indicate additional, or more specific, questions that may be associated with the selections.

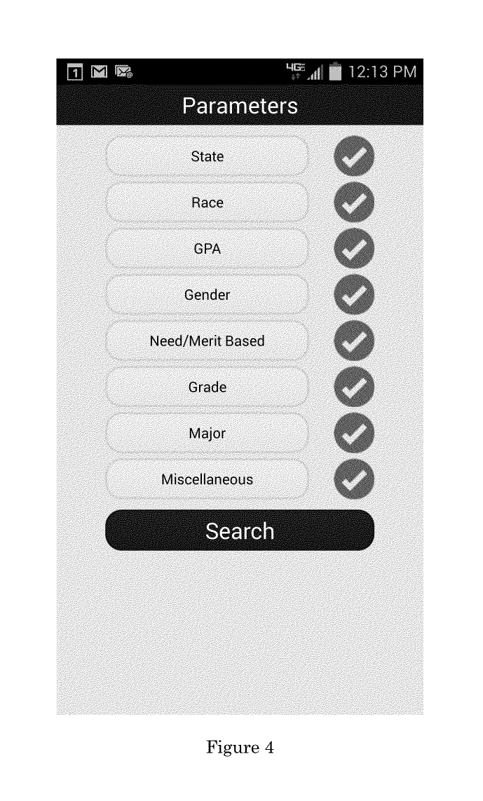

FIG. 4 is an example of another interface page of the Scholly app requesting biographical information. As shown in FIG. 4, the Scholly app includes eight (8) parameters to be used in searching for scholarships for a student. As shown in FIG. 4, the Scholly app allows a student to enter state information, race/ethnicity information, grade point average information, gender information, need/merit based information, grade level information, major information, and miscellaneous information. While the example shown in FIG. 4 includes these eight parameters, any number of parameters may be used, in addition to the listed parameters or instead of the listed parameters. Each of the parameters is associated with an input field, by selecting an input field, a student may fill in information associated with that parameter. Once the Scholly app has received information, the Scholly app places a green checkmark next to the parameter to indicate information has been received. The Scholly app may transmit this information to the information management server for storage.

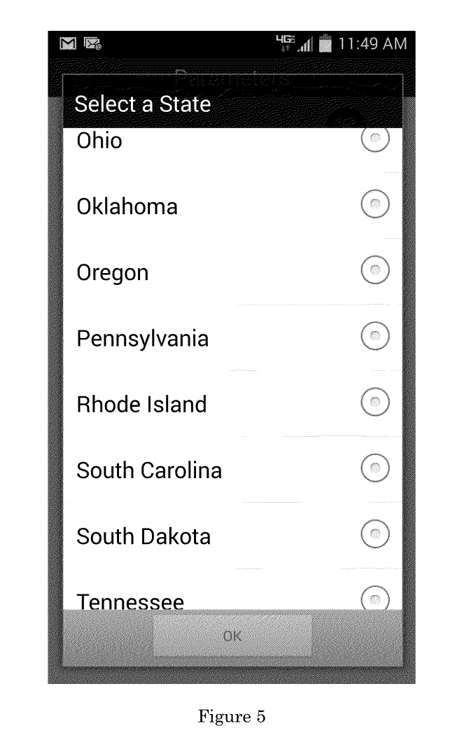

FIG. 5 is an example of another interface page of the Scholly app requesting state information. As shown in FIG. 5, the Scholly app requests information from the student regarding either the state where the student resides or attends school. The input fields allow a student to select a state associated with the student or school attended by the student. Once this information is entered, the information management server may receive this information and use it to generate scholarship suggestions.

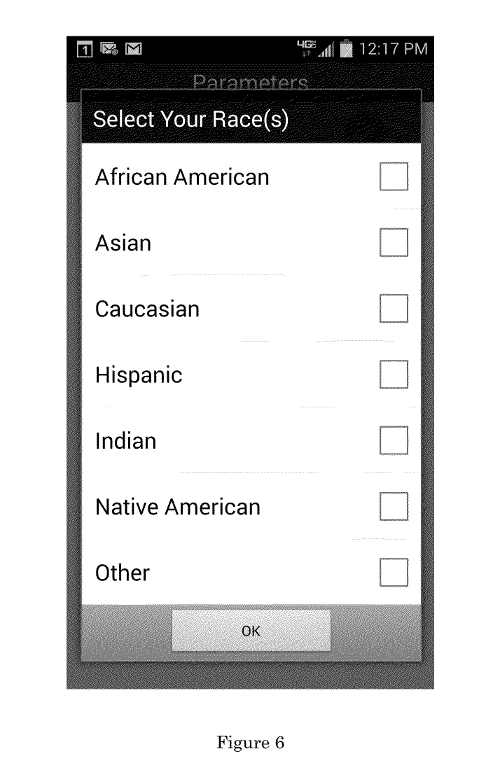

FIG. 6 is an example of another interface page of the Scholly app requesting race information. As shown in FIG. 6, the Scholly app requests information from the student regarding the student's race(s) or ethnicity. The input fields allow a student to select a race(s) or ethnicity. Once this information is entered, the information management server may receive this information and use it to generate scholarship suggestions.

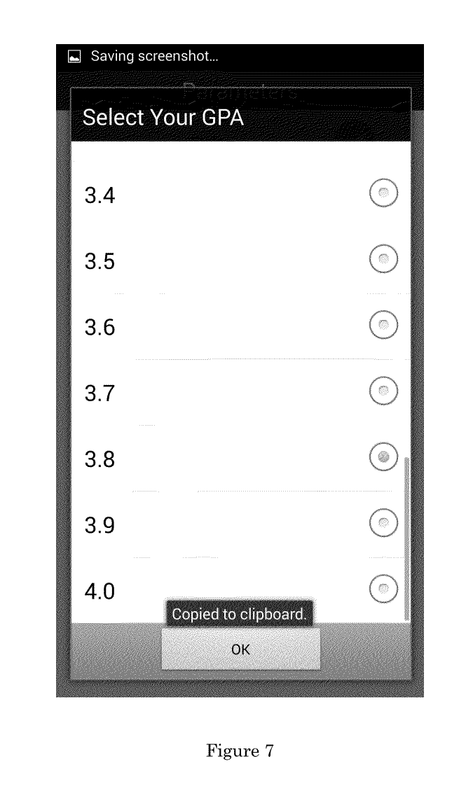

FIG. 7 is an example of another interface page of the Scholly app requesting grade point average (GPA) information. As shown in FIG. 7, the Scholly app requests information from the student regarding the student's GPA. The input fields allow a student to select a GPA. While the example shown is based on a four point GPA scale, this may be adjusted. Once this information is entered, the information management server may receive this information and use it to generate scholarship suggestions.

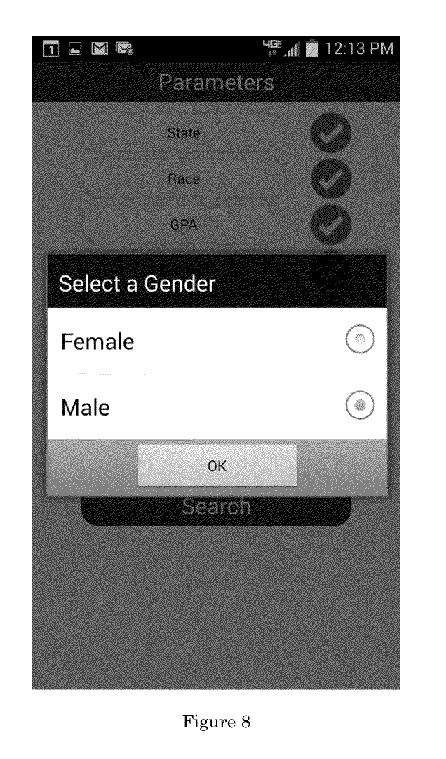

FIG. 8 is an example of another interface page of the Scholly app requesting gender information. As shown in FIG. 8, the Scholly app requests information from the student regarding the student's gender. The input fields allow a student to select a gender. Once this information is entered, the information management server may receive this information and use it to generate scholarship suggestions.

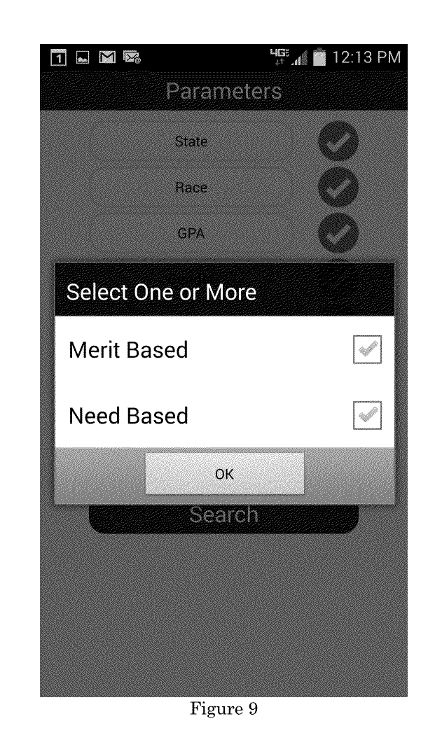

FIG. 9 is an example of another interface page of the Scholly app requesting need/merit based information. As shown in FIG. 9, the Scholly app requests information from the student regarding whether the student is searching for need and/or merit based scholarships. The input fields allow a student to select one or more of the options. Once this information is entered, the information management server may receive this information and use it to generate scholarship suggestions.

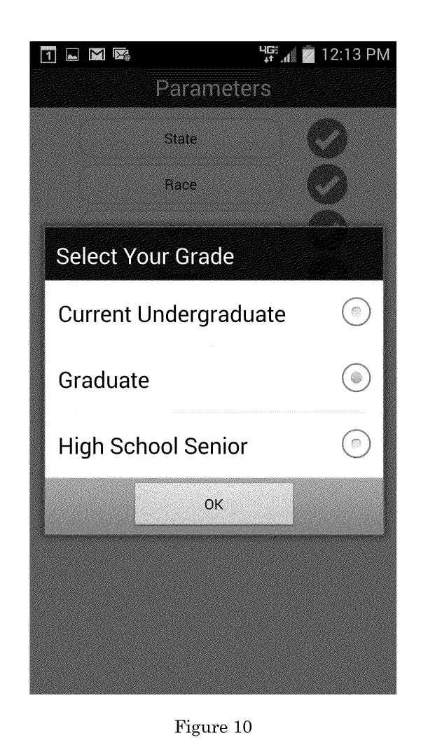

FIG. 10 is an example of another interface page of the Scholly app requesting grade level information. As shown in FIG. 10, the Scholly app requests information from the student regarding the current grade level of the student. The input fields allow a student to select his/her grade level. Once this information is entered, the information management server may receive this information and use it to generate scholarship suggestions.

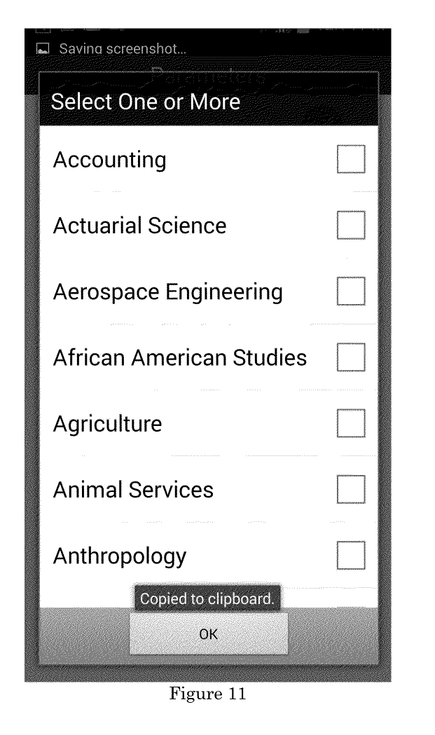

FIG. 11 is an example of another interface page of the Scholly app requesting major information. As shown in FIG. 11, the Scholly app requests information from the student regarding the student's current or intended major. The input fields allow a student to select one or more majors. This may provide the student with guidance on which majors to seek to minimize student loan debt. Once this information is entered, the information management server may receive this information and use it to generate scholarship suggestions.

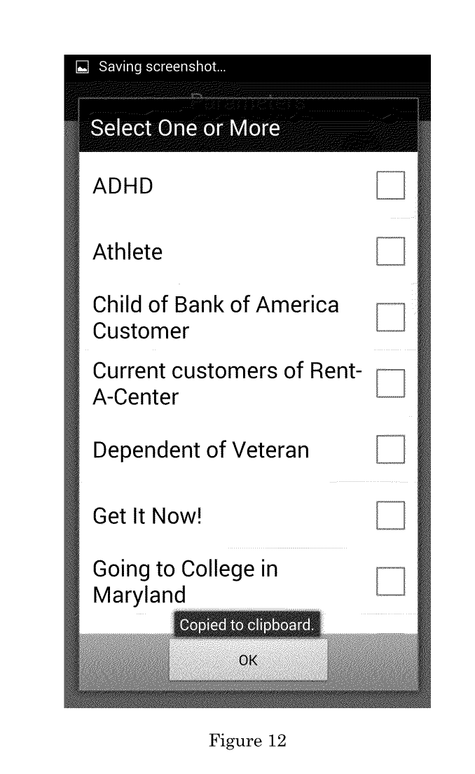

FIG. 12 is an example of another interface page of the Scholly app requesting miscellaneous information. As shown in FIG. 12, the Scholly app requests information from the student regarding the miscellaneous. The information management server is configured to parse scholarship criteria and determine additional criteria under which scholarships are offered. The input fields allow a student to select one or more miscellaneous selections. Once this information is entered, the information management server may receive this information and use it to generate scholarship suggestions.

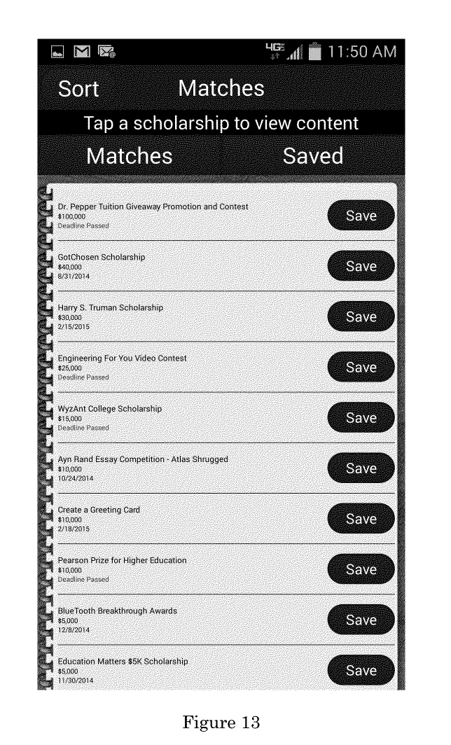

FIG. 13 is an example of another interface page of the Scholly app showing scholarship matches. As shown in FIG. 13, the page may include multiple input fields. Once the Scholly app has received the student's biographical information, the Scholly app provides the student with a formatted list of scholarship matches. The input fields allow a student to select a scholarship to review additional information, to save a particular scholarship for later viewing, to view only saved scholarships, and to sort the scholarships based on additional criteria.

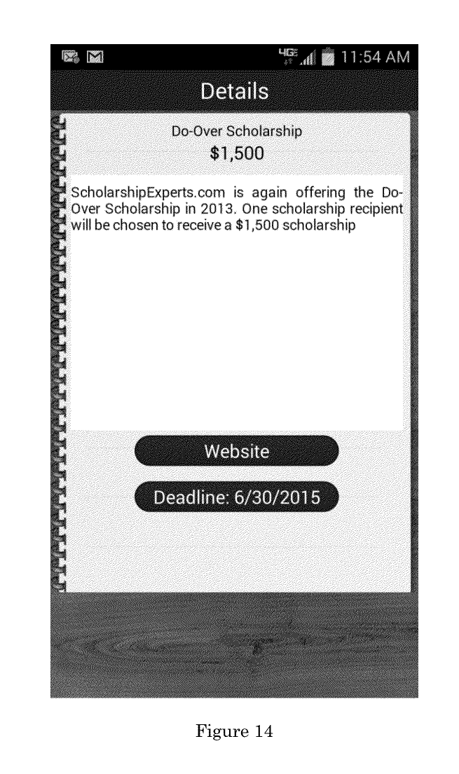

FIG. 14 is an example of another interface page of the Scholly app showing details regarding a selected scholarship. As shown in FIG. 14, the page may include multiple input fields. Once a student has selected a scholarship for additional viewing, the user is presented with additional details regarding the scholarship. This includes the grantor of the scholarship and other information provided by the Scholarship server via the API. The input fields allow a student to access a website associated with the grantee organization, or to directly apply for the scholarship using stored data.

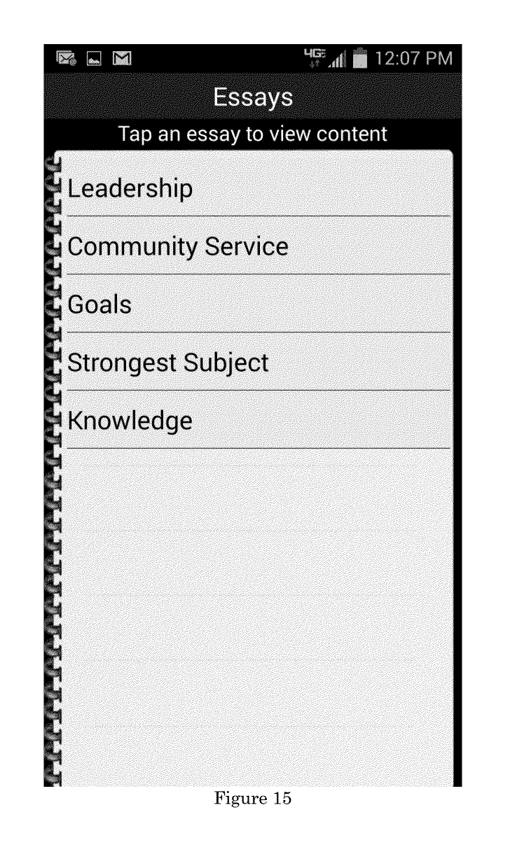

FIG. 15 is an example of another interface page of the Scholly app for a student wanting to view exemplary scholarship essays. As shown in FIG. 16, the page may include multiple input fields. The input fields allow a student to access essays focusing on a particular subject matter or scope. Scholly's essay bank may also be accessed by the Scholarship grantor to search for plagiarism and other unauthorized activities.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or Bluray-Disc, or other type of device for electronic data storage.

Although the methods and features described above with reference to FIGS. 2-15 are described above as performed using the exemplary system of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-15 may be used alone without the other features and elements or in various combinations with or without other features and elements. Sub-elements of the methods and features described above with reference to FIGS. 1-15 may be performed in any arbitrary order (including concurrently), in any combination or sub-combination.

What is claimed is:

1. A method for distributing scholarship information over a communications network to a student's network computing device, the method comprising:
providing a scholarship viewer application to a student for installation on the student's network computing device, the student's network computing device comprising a processor, a memory operatively connected to the processor, a communications unit for transmitting and receiving data via the communications network, and a display unit for displaying information to the student, the scholarship viewer application providing via the display unit input fields for receiving student information;
receiving, at an information management server, scholarship criteria information sent from a scholarship server via the communications network, the information management server comprising a respective processor, a respective communications unit for transmitting and receiving data via the communications network, and a respective memory that stores received scholarship criteria information, student information, information format requirements for the scholarship viewer application, and instructions for distributing scholarship information via the scholarship viewer application, wherein the processor:
filters the scholarship information by comparing the received scholarship criteria for a plurality of a scholarships to student's received student information;
generates a list of matching scholarships for a student that contains the scholarship information for which associated scholarship criteria is compatible with the student's student information;
formats the list of matching scholarships into data according to said information format requirements for the scholarship viewer application; and
transmits the formatted list of matching scholarships over the communications network to the network computing device associated with the student;
wherein the scholarship viewer application causes the list of matching scholarships received via the communications network to display on the student's network computing device.

2. The method of claim 1, wherein the student information comprises at least one of:
geographical information, race information, grade point average information, gender information, grade information, and major information.

3. The method of claim 1, wherein the processor of the information management server further:
parses received scholarship criteria to determine additional criteria under which scholarships are offered.

4. The method of claim 3, wherein the processor of the information management server further:
transmits the additional criteria over the communications network to the network computing device associated with the student, wherein the scholarship viewer application causes the additional criteria received via the communications network to display on the student's network computing device.

5. The method of claim 4, wherein the processor of the information management server further:
receives the student's selection of at least one miscellaneous selection corresponding to one of the additional criteria;
filters the scholarship information by comparing the additional criteria for a plurality of a scholarships to student's received miscellaneous selection;
generates a suggestion list of matching scholarships for a student that contains the scholarship information for which associated additional criteria is compatible with the student's miscellaneous selection;
formats the suggestion list of matching scholarships into data according to said information format requirements for the scholarship viewer application; and
transmits the formatted suggestion list of matching scholarships over the communications network to the network computing device associated with the student;
wherein the scholarship viewer application causes the suggestion list of matching scholarships received via the communications network to display on the student's network computing device.

6. The method of claim 1 wherein the processor of the information management server further:
downloads scholarship information from the scholarship server and stores the scholarship information in the memory of the information management server; and
in response to a request for viewing detailed scholarship information from the student's network computing device, the information management server transmitting the detailed scholarship information over the communications network to the network computing device associated with the student.

7. The method of claim 1, wherein the processor of the information management server further:
in response to a request for viewing stored essays from the student's network computing device, the information management server transmitting stored essays over the communications network to the network computing device associated with the student, wherein the scholarship viewer application causes the stored essays received via the communications network to display on the student's network computing device.

8. The method of claim 1, wherein the processor of the information management server further:
in response to a request to apply for a selected scholarship from the student's network computing device, the information management server transmitting over the communications network to the network computing device associated with the student, information directing the student to a web page containing instructions for applying for the selected scholarship.

9. The method of claim 1, wherein the processor of the information management server further:
in response to a request to apply for a selected scholarship from the student's network computing device, the information management server transmitting over the communications network to the scholarship server stored student information previously provided by the student via the student's network computing device, wherein the information management server permits the student to apply directly for the scholarship using stored student information.

10. The method of claim 9, wherein the stored student information is retrieved from the student's network computing device.

11. The method of claim 9, wherein the stored student information is retrieved from the information management server.

12. A method for providing scholarship information to a student, implemented in a network device, the method comprising:
accessing a scholarship server and downloading scholarship information and storing the scholarship information in a database;
automatically categorizing the scholarship information;
receiving a request for scholarship matching from a mobile device, wherein the request includes biographical information;
determining, based on a computer based algorithm, at least one scholarship match based on the scholarship information stored in the database and the received biographical information; and
transmitting the determined at least one scholarship match to the mobile device in a format that may be displayed on an app stored on the mobile device.

13. The method of claim 12 wherein the biographical information includes at least one of: geographical information, race information, grade point average information, gender information, grade information, and major information.

14. An information management server for distributing scholarship information over a communications network to a student's network computing device, the information management server comprising:
a processor;
a communications unit for transmitting and receiving data via a communications network;
a memory operatively connected to the processor, the memory storing:
scholarship criteria information, student information, information format requirements for the scholarship viewer application, and instructions for distributing scholarship information via the scholarship viewer application, said instructions comprising instructions for causing the processor to:
filter the scholarship information by comparing the received scholarship criteria for a plurality of a scholarships to student's received student information;
generate a list of matching scholarships for a student that contains the scholarship information for which associated scholarship criteria is compatible with the student's student information;
format the list of matching scholarships into data according to said information format requirements for the scholarship viewer application; and
transmit the formatted list of matching scholarships over the communications network to the network computing device associated with the student.

15. The information management server of claim 14, further comprising instructions stored in the memory for causing the processor to:
parse received scholarship criteria to determine additional criteria under which scholarships are offered.

16. The information management server of claim 15, further comprising instructions stored in the memory for causing the processor to:
transmit the additional criteria over the communications network to the network computing device associated with the student.

17. The information management server of claim 16, further comprising instructions stored in the memory for causing the processor to:
receive the student's selection of at least one miscellaneous selection corresponding to one of the additional criteria;
filter the scholarship information by comparing the additional criteria for a plurality of a scholarships to student's received miscellaneous selection;
generate a suggestion list of matching scholarships for a student that contains the scholarship information for which associated additional criteria is compatible with the student's miscellaneous selection;
format the suggestion list of matching scholarships into data according to said information format requirements for the scholarship viewer application; and
transmits the formatted suggestion list of matching scholarships over the communications network to the network computing device associated with the student.

18. A network computing device for viewing scholarship information, the network computing device comprising:
a processor;
a communications unit for transmitting and receiving data via a communications network;
a display unit for displaying information to the student; and
a memory operatively connected to the processor, the memory storing a scholarship viewer application for causing the processor to:
provide via the display unit input fields for receiving student information;
transmit over the communications network to an information management server received student information;
receive over the communications network a formatted list of matching scholarships; and
cause the list of matching scholarships received via the communications network to display on the display unit.
